(19) United States
(12) Patent Application Publication
(10) Pub. No.: US 2008/0106695 A1
(43) Pub. Date: May 8, 2008

(54) Low battery indicator for electro-active spectacles

(76) Inventors: William Kokonaski, Gig Harbor, WA (US); James J. Bochnowski, Atherton, CA (US); Ronald D. Blum, Roanoke, VA (US); Joshua N. Haddock, Roanoke, VA (US)

Correspondence Address: Pearl Cohen Zedek Latzer, LLP, 1500 Broadway, 12th Floor, New York, NY, 10036, US

(21) Appl. No.: 11/976,309

(22) Filed: Oct. 23, 2007

Related U.S. Application Data
(60) Provisional application No. 60/853,470, filed on Oct. 23, 2006.

(51) Int. Cl. G02C 7/06; G08B 21/00; H02J 7/00

(52) U.S. Cl. 351/172; 340/636.1; 320/137

(57) ABSTRACT

A low power indicator for electro-active spectacle lenses is presented in which the low power indicator is a part of a controller for the electro-active spectacle lenses or is operably connected to the controller. The low power indicator may generate a signal when the power of the power source for the electro-active spectacle lenses is low. The signal may be used by the controller, or other circuitry to activate an indication to a user of the lenses that the power is low. Such an indication may be periodically activating and deactivating one of an optical power of the electro-active lenses, a vibration source, a visible light source, or an audible sound source.

### CROSS REFERENCE TO RELATED APPLICATIONS

This application claims priority from and incorporates by reference in its entirety provisional application U.S. Ser. No. 60/853,470 filed on 23 Oct. 2006 and entitled “Low Battery Indicator for Electro-Active Spectacles”.

### BACKGROUND OF THE INVENTION

1. Field of the Invention

The present invention relates to indicating to a user a low power condition of a power source. More specifically, the present invention relates to indicating to a user a low power condition of a power source which powers the user's electro-active spectacles so that the user may have advance notice that the power source needs to be recharged or replaced if the user is to continue enjoying the benefits of the electro-active spectacle lenses.

2. Description of the Related Art

Many patents have been granted relating to a variety of electro-active spectacle lenses which are powered by a power source. However; these patents are absent any teaching of a device or method which may be used to alert the user of the electro-active spectacle lenses that the power source is in a low power condition. For example in U.S. Pat. No. 7,009,757 Nishioka, et al., discusses a variety of features of electro-active spectacles for correcting vision, but does not discuss the need for a low power indicator. In U.S. Pat. No. 5,359,444 Piosenka, et al., discusses a pail of electro-active spectacles controlled by a rangefinder but fails to discuss the need for a low power indicator. Various other patents published before these cited references also fail to discuss the need for an indicator that will allow a user to know that the power source of the user's electro-active spectacles is in a low power, state.

One application of electro-active lenses for spectacle wearers includes the correction of presbyopia. In such applications, the electro-active lenses typically provide the wearer's required near distance vision power, while the wearer's required far distance vision correction is provided by a conventional, non-electro-active optical correction. In such applications it is advantageous for the wearer to have advanced notice that the power source of the electro-active spectacles is running low, so as to avoid a situation where the wearer is suddenly no longer able to read or view objects up close when the power source is no longer able to power the lenses.

Therefore, there is a need for a variety of techniques for alerting the user of electro-active spectacle lenses that the power source powering the electro-active spectacle lenses is reaching a point where either the power source need to be recharged or replaced.

### SUMMARY OF THE INVENTION

In an embodiment of the invention, spectacles housing an electro-active lens may include a power source. The spectacles may further include a low power indicator for producing a signal indicating a low power condition of the power source. The spectacles may further include a controller for receiving the signal from the low power indicator and for periodically activating and deactivating an optical power of the electro-active lens based on the signal.

In an embodiment of the invention, spectacles housing an electro-active lens may include a power source. The spectacles may further include a low power indicator for producing a signal indicating a low power condition of the power source. The spectacles may further include a vibration source for receiving the signal from the low power indicator and for periodically vibrating based on the signal.

In an embodiment of the invention, spectacles housing an electro-active lens may include a power source. The spectacles may further include a low power indicator for producing a signal indicating a low power condition of the power source. The spectacles may further include a light source for receiving the signal from the low power indicator and for periodically illuminating and extinguishing a light from the light source based on the signal.

In an embodiment of the invention, spectacles housing an electro-active lens may include a power source. The spectacles may further include a low power indicator for producing a signal indicating a low power condition of the power source. The spectacles may further include a sound source for receiving the signal from the low power indicator and for periodically producing an audible sound from the sound source based on the signal.

In an embodiment of the invention, a charging station for electro-active spectacles having a power source may include a charging device for coupling the charging station with the power source of the electro-active spectacles and for charging the power source while coupled. The charging station may further include a low power indicator for producing a signal indicating a low power condition of the power source. The charging station may further include an output device for receiving the signal from the low power indicator and indicating to a user whether the low power condition exists within the power source.

### BRIEF DESCRIPTION OF THE DRAWINGS

A specific embodiment of the present invention will be described with reference to the following drawings, wherein:

FIG. 1 illustrates an embodiment of a low power indicator circuit.

### DESCRIPTION OF THE PREFERRED EMBODIMENT

A low power indicator refers to circuitry which monitors a low power condition of a power source which powers electro-active lenses housed in a pair of spectacles. The power source may be a battery, a fuel cell, a solar power cell, or other devices capable of producing electrical power. The power source may be located within the spectacle frame or may be embedded within the electro-active lens. A “low power condition” may mean that a voltage of the power source is below a threshold. A “low power condition” may mean that a current of the power source is below a threshold. A “low power condition” may mean that a power of the power source is below a threshold. A “low power condition” may mean that an impedance of the power source is above a threshold. A “low power condition” may mean that the power source may not be able to provide for operation of the electro-active spectacle lenses for more than a predetermined amount of time.

The low power indication circuitry may be associated with the frame of the electro-active spectacle lenses. For example, the low power indication circuitry may be located in the frame, on the frame, attached to the frame, or remotely connected to the frame. The low power indication circuitry may be associated with the electro-active lenses. For example, the low power indication circuitry may be located in the lens, on the lens, attached to the lens, or remotely connected to the lens.

The low power indicator circuitry may be part of a controller which controls the optical power of the electro-active spectacle lenses. A controller may be a CPLD, an FPGA, a processor, a microprocessor, a microcontroller, a DSP, or any device capable of controlling the optical power of the electro-active spectacle lenses. Alternatively, the low power indication circuitry may be separate from the controller or the processor. The low power indicator may output a signal to indicate a low power condition. Alternately, the low power indicator may output a signal to indicate that there is no low power condition. The low power indicator may be operably connected to the controller or the processor. The low power indicator may be operably connected to other circuitry such as a visible light source, an audible sound source, or a vibration source.

Because the power of the power source may vary, in some embodiments of the present invention when a low power condition is detected by the low power indicator, it may latch this condition. In such an embodiment, once a low power condition is detected the indicator will continue to indicate a low power condition until reset. Thus, the user will not be bothered by an indicator that turns on and off due to the natural fluctuations of the power source above and below a threshold. The low power indicator may be reset by charging the electro-active spectacle lenses or by resetting the indicator.

In a first embodiment of the present invention, a low power indicator is part of or is operably connected to a controller which controls the optical power of a user's electro-active spectacle lenses. The low power indicator may generate a signal when a low power condition exists in the power source which powers the electro-active spectacle lenses. The signal may cause the controller to periodically activate and deactivate the optical power of the electro-active spectacle lenses such that the optical power of the lenses turns on and off in a periodic mariners.

In a second embodiment of the present invention, a low power indicator is part of or is operably connected to a vibration source. The vibration source may be located in the temple portion of the frame of a user's electro-active spectacle lenses. The vibration source may be capable of generating a low amplitude vibration. The low power indicator may generate a signal when a low power condition exists in the power source which powers the electro-active spectacle lenses. The signal may cause the vibration source to periodically generate a low amplitude vibration to the user's head. The vibration may be noticeable by the user but not overly annoying as to be uncomfortable or overly disconcerting to the user.

In a third embodiment of the present invention, a low power indicator is part of or is operably connected to a visible light source. The light source may be located such that a user of electro-active spectacle lenses can see the light source when it is illuminated. The low power indicator may generate a signal when a low power condition exists in the power source which powers the electro-active spectacle lenses. The signal may cause the light source to periodically illuminate and extinguish. The amplitude, frequency of visible light, and periodicity of illuminating and extinguishing of the flashing light may be optimized so as to be an adequate indicator which is easily noticed by the user, but not overly intrusive so as to be disconcerting to the user.

In a fourth embodiment of the present invention, a low power indicator is part of or is operably connected to an audible sound source. The sound source may be located such that a user of electro-active spectacle lenses can hear the sound source when it is producing sound. The low power indicator may generate a signal when a low power condition exists in the power source which powers the electro-active spectacle lenses. The signal may cause the sound source to periodically produce an audible sound. The amplitude, frequency of audible sound, and periodicity of the sound may be optimized so as to be an adequate indicator which is easily noticed by the user, but not overly intrusive so as to be disconcerting to the user.

In a fifth embodiment of the present invention, the electro-active spectacles may be placed in a charging station that has a low power indicator that can sense the power of the spectacle's power source. The charging station may have a charging device which, when coupled to the power source of the electro-active spectacles, is capable of charging the power source. The charging device may couple to the power source through a connector or wirelessly such as through inductive charging. The low power indicator may provide an output signal to an output device which can be utilized to indicate whether a lower power condition exists in the power source of the electro-active spectacles. The output signal may be an indication of an amount of power remaining in the power source. Alternately, this indication may be a voltage, a current, a power, or a time remaining during which there is enough power to operate the lenses. The output device may be a visual display device, one or more Light Emitting Diodes (LEDs), a Liquid Crystal Display (LCD) screen, an electro-chromatic device, a sound source, or any other device capable of informing a user that a low power condition exists in the power source of the spectacles.

In still other embodiments of the present invention, small LEDs may be placed on the frame of the electro-active spectacles. The LEDs may be placed on a side of the drive circuit. The LEDs may indicate the amount of power remaining by either the color of the diode that is lit or the number of diodes that are lit, thereby forming a simple power level scale. Alternatively, a single diode may be lit to indicate simply that power is low.

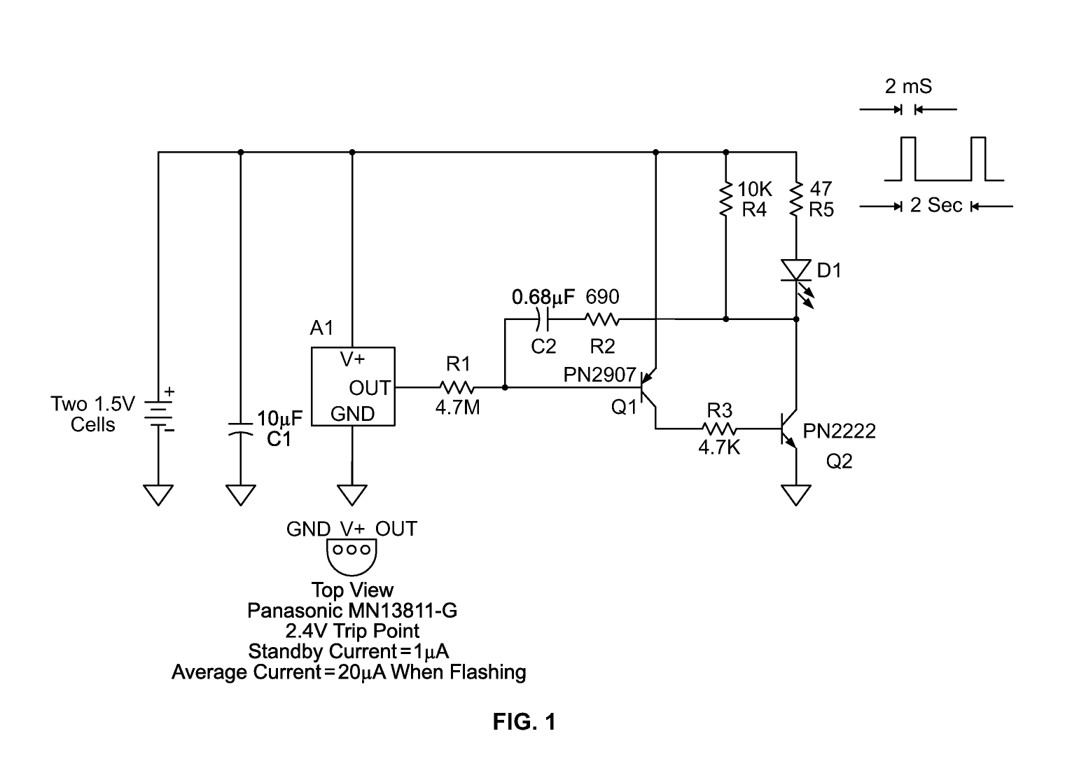

FIG. 1 illustrates an embodiment of a low power indicator circuit as described in a publication of EDN, dated 2 Jan. 1997, designed by David Johnson and Associates. Such a design is typical of low power indicators used in low voltage battery powered devices, and are well know to those of ordinary skill in the art.

Such a circuit may be ideal for the embodiment described above having a visible light source. The circuit design shown in FIG. 1 draws only 1 microampere in the off state and only 20 microamperes while flashing an LED.

While the circuit in FIG. 1 illustrates a flashing LED as an indicator, the driver chip MN13811-G could also be used to chive other indicators described above. For example the output could be sent to the controller of the electro-active lenses. When the controller senses the output signal of the MN13811-G indicating a low power condition, it may change the drive voltage(s) applied to the electro-active lenses. Such a change in drive voltage(s) may periodically toggle the optical power of the electro-active lenses between substantially zero optical power and a substantially non-zero optical power, thereby alerting the wearer of the lenses of a low power condition.

Alternately, the output signal of the MN13811-G may be used to drive a vibration source such as, by way of example only, a thin piezoelectric strip. The piezoelectric strip may be located in one or both of the frame temples. The piezoelectric strip may be capable of generating a low amplitude vibration to the side of the wearer's head indicating that a low power condition exists in the power source used to power the electro-active spectacles.

It should be pointed out that other low power indication circuits exist and are well known in the art. Such low power indication circuits are considered within the scope of the present invention. Furthermore, the lower power indicator circuit shown in FIG. 1 is only provided as an illustrative example and is in no way meant to limit the scope of the present invention to only this embodiment.

What is claimed is:

1. Spectacles housing an electro-active lens, comprising:
a power source;
a low power indicator for producing a signal indicating a low power condition of said power source; and
a controller for receiving said signal from said low power indicator and for periodically activating and deactivating an optical power of the electro-active lens based on said signal.

2. The spectacles of claim 1, wherein said low power indicator is associated with a frame of the spectacles.

3. The spectacles of claim 1, wherein said low power indicator is associated with the electro-active lens.

4. The spectacles of claim 1, wherein said low power condition is selected from the group consisting of a voltage of said power source below a voltage threshold, a current of said power source below a current threshold, a power of said power source below a power threshold, an impedance of said power source above an impedance threshold, and a time said power source is able to provide for operation of the electro-active lens less than a predetermined amount of time.

5. The spectacles of claim 1, wherein said low power condition is latched by said low power indicators.

6. Spectacles housing an electro-active lens, comprising:
a power source;
a low power indicator for producing a signal indicating a low power condition of said power source; and
a vibration source for receiving said signal from said low power indicator and for periodically vibrating based on said signal.

7. The spectacles of claim 6, wherein said low power indicator is associated with a frame of the spectacles.

8. The spectacles of claim 6, wherein said low power indicator is associated with the electro-active lens.

9. The spectacles of claim 6, wherein said low power condition is selected from the group consisting of: a voltage of said power source below a voltage threshold, a current of said power source below a current threshold, a power of said power source below a power threshold, an impedance of said power source above an impedance threshold, and a time said power source is able to provide for operation of the electro-active lens less than a predetermined amount of time.

10. The spectacles of claim 6, wherein said low power condition is latched by said low power indicators.

11. The spectacles of claim 6, wherein said vibration source is a piezoelectric strip.

12. Spectacles housing an electro-active lens, comprising:
a power source;
a low power indicator for producing a signal indicating a low power condition of said power source; and
a light source for receiving said signal from said low power indicator and for periodically illuminating and extinguishing a light from said light source based on said signal.

13. The spectacles of claim 12, wherein said low power indicator is associated with a frame of the spectacles.

14. The spectacles of claim 12, wherein said low power indicator is associated with the electro-active lens.

15. The spectacles of claim 10, wherein said low power condition is selected from the group consisting of a voltage of said power source below a voltage threshold, a current of said power source below a current threshold, a power of said power source below a power threshold, an impedance of said power source above an impedance threshold, and a time said power source is able to provide for operation of the electro-active lens less than a predetermined amount of time.

16. The spectacles of claim 10, wherein said low power condition is latched by said low power indicator.

17. The spectacles of claim 10, wherein said light source is at least one light emitting diode.

18. Spectacles housing an electro-active lens, comprising:
a power source;
a low power indicator for producing a signal indicating a low power condition of said power source; and
a sound source for receiving said signal from said low power indicator and for periodically producing an audible sound from said sound source based on said signal.

19. The spectacles of claim 18, wherein said low power indicator is associated with a frame of said spectacles.

20. The spectacles of claim 18, wherein said low power indicator is associated with the electro-active lens.

21. The spectacles of claim 18, wherein said low power condition is selected from the group consisting of: a voltage of said power source below a voltage threshold, a current of said power source below a current threshold, a power of said power source below a power threshold, an impedance of said power source above an impedance threshold, and a time said power source is able to provide for operation of the electro-active lens less than a predetermined amount of time.

22. The spectacles of claim 18, wherein said low power condition is latched by said low power indicator.

23. A charging station for electro-active spectacles having a power source, comprising:
a charging device for coupling the charging station with the power source of the electro-active spectacles and for charging the power source while coupled;
a low power indicator for producing a signal indicating a low power condition of the power source; and
an output device for receiving said signal from said low power indicator and indicating to a user whether said low power condition exists within the power source.

24. The charging station of claim 23, wherein said low power condition is selected from the group consisting of: a voltage of said power source below a voltage threshold, a current of said power source below a current threshold, a power of said power source below a power threshold, an impedance of said power source above an impedance threshold, and a time said power source is able to provide for operation of the electro-active lens less than a predetermined amount of time.

25. The charging station of claim 23, wherein said output means is selected from the group consisting of a visual display device, one or more light emitting diodes, a liquid crystal display, an electro-chromatic device, and a sound source.
